(19) United States
(12) Patent Application Publication
(10) Pub. No.: US 2006/0062499 A1
(43) Pub. Date: Mar. 23, 2006

(54) Integrated hydrodynamic air bearing and seal

(76) Inventor: Gary L. Boyd, Durango, CO (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/101,172

(22) Filed: Apr. 6, 2005

Related U.S. Application Data
(60) Provisional application No. 60/560,796, filed on Apr. 8, 2004.

(51) Int. Cl. F16C 32/06

(52) U.S. Cl. 384/100

(57) ABSTRACT

A pressurized hydrodynamic bearing and seal assembly for radial and/or thrust bearings includes a stationary bearing member formed of a carbon/graphite material positioned adjacent a rotating member so as to define a space between the members when the respective bearing segments are rotating with respect to each other. In one form, the carbon/graphite is positioned in the outer stationary position and the inner member is fixed to a rotating shaft. The inner member may be formed of a metallic material or a ceramic or ceramic composite. The operation of the bearing is improved by including a seal dam along an axial end of the stationary carbon/graphite member so as to prevent leakage of gases accumulating between the inner and outer members. In this form, the gas pressure can be increased substantially so as to increase the load capacity of the bearing. The system also includes a thrust bearing of substantially the same type of construction but oriented to absorb the thrust motion. The thrust bearing also includes a seal dam so that the capacity of the thrust bearing can be increased by additional gas pressure between the rotating and non-rotating bearing surfaces.

### SPECIFIC DATA RELATED TO APPLICATION

This application claims the benefit of U.S. Provisional Application No. 60/560,796 filed Apr. 8, 2004.

The present invention relates to bearings and seals, and more particularly, to pressurized hydrodynamic bearings and seals in which the bearing can be used in both a radial and/or thrust application.

### BACKGROUND OF THE INVENTION

Two types of air bearings are well known in the art. Typically, air bearings are either a metallic foil type bearing or a magnetic bearing. Neither of these bearings requires the use of oil for lubrication although the foil bearing generally has various coatings applied to the foils to provide compliance to the journal. The foil bearing cannot be pressurized to increase bearing load capacity while the magnetic bearing is typically very complex, heavy and expensive.

Another form of non-lubricated, gas film loads support bearing is described in U.S. Pat. No. 5,017,022. In this support bearing, the rotating shaft is formed of a ceramic material such as silicon nitride and the surrounding bearing segments are of a carbon graphite material. The carbon graphite surface is configured with lands and depressions for self generation of a gas film from surrounding hot oxygen bearing gases. The gases are derived from the use of the bearing in a gas turbine engine. However, the film load support is provided at relatively low pressure and this system does not provide a means of increasing the pressure to provide higher bearing load capacities. The system described in the '022 patent was typically useful in the range of about 30 psi for a one inch bearing at a surface speed of approximately 525 feet per second. However, it is desirable to provide a bearing having a significantly larger load capacity such as a capacity in excess of 100 psi.

The graphite ceramic interface used in the '022 patent was further exploited in U.S. Pat. No. 6,322,081 in the development of a circumferential seal for sealing between a rotating shaft and a stationary housing. The seal in the '081 patent comprises a stator mounted to the housing and having a radially inward facing carbon portion and a rotor with a ceramic sealing member having a radially outward facing surface in rubbing contact with a carbon portion. This arrangement of carbon ceramic seal provided a substantially constant engagement between the carbon ring and the ceramic rotor in the presence of varying temperatures. This result is achieved because of the limited deformation of carbon and graphite at varying temperatures.

### BRIEF DESCRIPTION OF THE DRAWINGS

FIG. 1 is a cross-sectional view of one embodiment of a bearing-seal arrangement in accordance with the present invention;

FIG. 2 is an end view and FIG. 2a is a cross-sectional view of the radial outer stationary member of the bearing in FIG. 1; and

FIG. 3 is an end view and FIG. 3a is a cross-sectional view of another form of the radial outer stationary member of the bearing of FIG. 1.

### DETAILED DESCRIPTION OF THE INVENTION

The present invention is an improvement upon and modification of the bearing described in U.S. Pat. No. 5,017,022, the disclosure of which is hereby incorporated by reference. More particularly, the present invention combines the bearing element concept of the '022 patent with the concept of a carbon ring seal such as that described in U.S. Pat. No. 6,322,081 to create a pressurizable bearing and gain a proportionate increase in bearing load capacity.

In general, air bearing technology usually relates to self-energizing foil type air bearings in which a series of metallic foils and a circumferential array about a cylindrical shaft lift off the shaft during shaft rotation due to the formation of the boundary layer pressure gradient. Such air bearings are limited to load capacity due to foil conformance to the rotating bearing rotor. Non-conformance of the foil to the bearing rotor can interrupt the boundary layer pressure gradient and cause the foil to contact the rotating shaft thereby resulting in excessive frictional heating and bearing failure. Applicant's bearing concept utilizes a single piece or multi-piece segmented stationary bearing member of high density, fine-grained, high temperature, carbon/graphite material with cylindrical and/or radial surfaces that initially contact a rotating bearing journal. The bearing can either be a radial bearing and/or a thrust bearing and can be operated in conjunction with a metallic, ceramic or hybrid ceramic bearing journal.

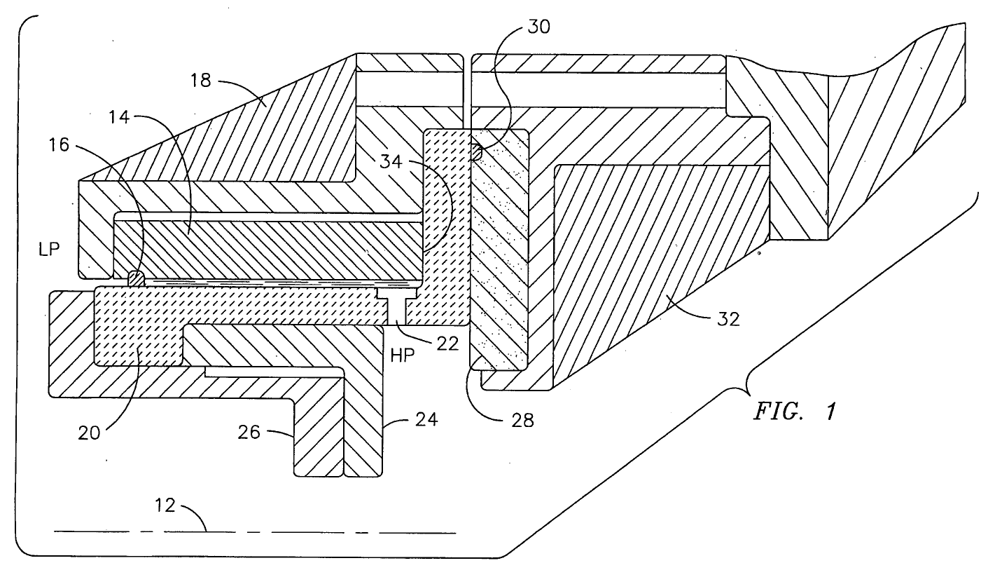

FIG. 1 illustrates one form of the present invention in which the functions of a bearing and seal are integrated into a single unit. In particular, FIG. 1 is a cross-sectional view of one form of hydrodynamic radial and thrust bearing arrangement utilizing a carbon/graphite radial and thrust bearing for interfacing with a rotating journal. Referring to FIG. 1, the rotating journal or center line of the rotating journal shaft is indicated at 12 while the circumferentially extending radial stationary bearing member is indicated at 14. The radial bearing member 14 is distinguishable from the bearing of the '022 patent by a seal dam 16 located at an axially inner end of the bearing member 14. The bearing member 14 is supported in an annular gusseted radial bearing support structure 18 which may be attached by conventional means to a housing of the assembly of which the bearing and shaft are a part. For example, the housing may be a housing of a turbine engine as described in the '022 patent. In the form illustrated in FIG. 1, the bearing member 14 is supported on a hot gas or air film created between the inner radial surface of the bearing member 14 and the underlying rotating bearing member 20. The rotating bearing member 20 may be a ceramic or ceramic composite material or as described above, a steel or other metallic material. As shown in FIG. 1, the gas to create the film between the rotating member 20 and the non-rotating radial bearing member 14 is admitted into the space between the two members through a plurality of apertures 22. The location of the aperture 22 feeds into a high pressure area indicated by the letters HP.

The rotating bearing member 20 is typically supported on an annular axial retainer 24 and a metallic flex beam 26, both of which elements are well known in the art. Both the elements 24 and 26 are mechanically fixed to the shaft indicated by shaft center line 12. The embodiment of FIG. 1 also incorporates a thrust bearing member 28 which may be formed substantially similar to the radial bearing member 14 and includes a seal dam 30 that also interfaces against the rotating bearing member 20. The thrust bearing member 28 is also formed of carbon or a carbon graphite composition and is mounted in a gusseted thrust bearing support structure 32 of a type well known in the art. It should also be noted that a forward edge of the circumferential or annular radial bearing member 14 has an anti-thrust bearing surface 34 which engages an axially rearward surface of the bearing member 20.

It can be seen that the embodiment of FIG. 1 provides both a support bearing structure utilizing a hydrodynamic air film and also provides a seal structure that allows the hydrodynamic air film to be presented at a higher pressure. As is well known, the ability of the bearing to support a specific rotor or shaft mass on a self-energizing hydrodynamic air film is the bearing's load capacity. By providing a bearing that incorporates both a seal and a hydrodynamic effect, the bearing is able to lift off the bearing journal under higher loads as shaft rotation increases so that the boundary layer pressures are sufficient to support a larger rotor mass. The air seal at 16 and 30 integrated into the radial and thrust bearing members 14 and 28 effectively seal the downstream end of the bearing surfaces so as to allow the higher pressure to accumulate under the bearing to increase load capacity of those bearings.

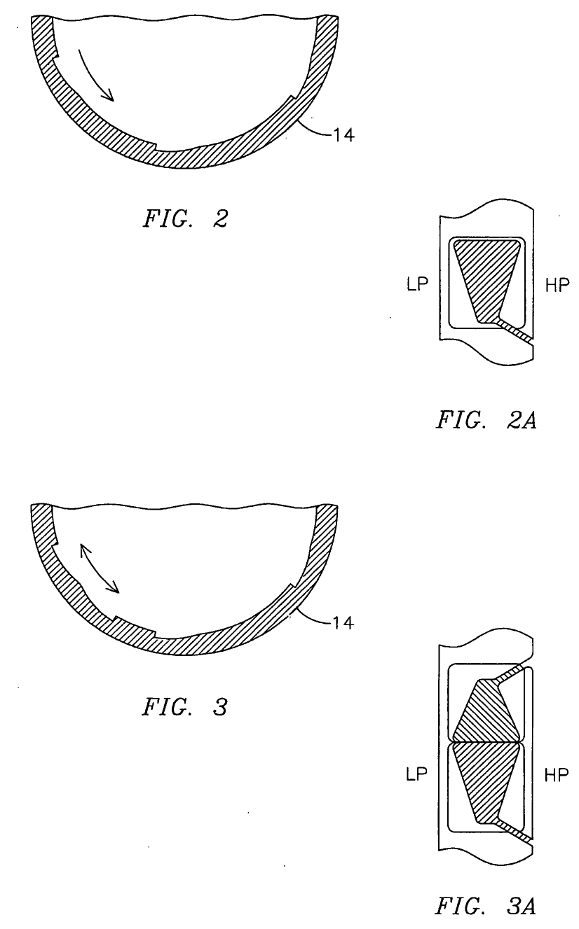

Referring to FIGS. 2 and 3, the effective lift pads formed on the radially inner surface of the bearing member 14 are utilized to create the increased pressure as the rotational speed of the adjacent bearing member 20 increases. The machined discontinuities on the inner surface of the annular outer bearing capture the air and cause the air to create a film which supports the bearing member 14 off of the adjacent bearing member 20. The design of the radial bearings illustrated in FIGS. 2 and 3 is also applied to the surface of the thrust bearing member 28 so that a hydrodynamic gas lifting effect separates member 28 from member 20. The bearings 14 and 28 each incorporate and integrate an air seal into the bearing radial and/or axial surfaces that can be used to effectively seal the downstream end of the bearing surfaces. In doing so, the high pressure buffer air can be channeled to the lift pads illustrated in FIGS. 2 and 3 thereby providing additional bearing lift or load capacity. FIG. 3 is used for bi-directional rotation while FIG. 2 is uni-directional. The increase of bearing load capacity is proportional to the air pressure that buffers the lift pad cavities and the integrated seal effecting this. It is believed that the present bearing with the integrated seal can increase the pressure within the space between the bearing elements such as elements 14 and 20 by at least 70 psi over the previously possible 30 psi achieved in the bearing described in the '022 patent. As previously mentioned, the use of the carbon/graphite bearing allows the underlying bearing member 20 to be either a metallic, ceramic or hybrid ceramic bearing rotor material. For example, the ceramic rotor material may be alumina (al₂o₃) and silicon nitride (si₃n₄). The use of these materials to interface with the carbon graphite bearing in frictional contact enables improved bearing robustness to otherwise prevent damaging the bearing under contact loads. By way of example and not by way of limitation, the graphite material of radial bearing 28 may be obtained from Poco sold under their Model Number HCF 10-QE-2. An exemplary ceramic bearing material to be used for the bearing element 20 may be the Kyocera type SN-235P pressureless sintered silicon nitride material. The combination of the two materials described above have demonstrated a radial journal bearing to surface speeds of 599 feet per second on a stable air film utilizing a fully bladed six pound radial ceramic turbine rotor with a smooth 1.375 inch outside diameter integral ceramic stub shaft surface at 100,000 rpm in free air. The radial bearing 34 may be either a single piece annular bearing or a segmented bearing. If the bearing is segmented, the ends of each segmented section must mate with an end of adjoining segment in a locking relationship so as to preclude high pressure air leakage through the joint between adjacent segments. The rotating bearing member 20 should have a surface smoothness of about 2-5 micro inch.

What has been described is an improved bearing/seal arrangement for a high speed rotating shaft in which the bearing is capable of increase loading utilizing high pressure air film to support an outer stationary bearing over an inner rotating bearing surface.

What is claimed is:

1. A pressurized hydrodynamic bearing assembly comprising:
an axially extending rotatable inner member having a smooth surface finish; and
an outer non-rotating member formed of a carbon/graphite material and adapted to be hydrodynamically supported above a surface of said inner rotating member when the rotational speed of said surface reaches a predetermined value, said outer stationary member including a radially inward extending sealing dam positioned at an axially inner end of said stationary member for preventing leakage of gas from beneath said non-rotating member.

2. The pressurized hydrodynamic bearing assembly of claim 1 wherein the inner rotating member on said rotating shaft comprises a ceramic material.

3. The pressurized hydrodynamic bearing assembly of claim 1 and including a radially outward extending annular bearing segment connected to an axial end of said inner member and another carbon/graphite stationary member positioned in thrust bearing relationship with said bearing segment.

4. The pressurized hydrodynamic bearing assembly of claim 3 and including a seal dam positioned about an outer radial edge of said another stationary member for preventing gas leakage from a space between said bearing segment and said another stationary member.
